(19) United States
(12) Patent Application Publication
(10) Pub. No.: US 2004/0036249 A1
(43) Pub. Date: Feb. 26, 2004

(54) Pedal driven scooter

(76) Inventors: Mark J. McGuire, Redondo Beach, CA (US); Neal T. Saiki, Scotts Valley, CA (US)

Correspondence Address: FULWIDER PATTON LEE & UTECHT, LLP, 200 OCEANGATE, SUITE 1550, LONG BEACH, CA, 90802, US

(21) Appl. No.: 10/448,879

(22) Filed: May 30, 2003

Related U.S. Application Data
(60) Provisional application No. 60/385,045, filed on Jun. 1, 2002.
(60) Provisional application No. 60/417,111, filed on Oct. 9, 2002.

(51) Int. Cl. B62M 1/00

(52) U.S. Cl. 280/253

(57) ABSTRACT

A lightweight scooter with a pedal driven propulsion system incorporates a foot pedal mounted on a chassis that drives an idler sprocket to provide tension on a chain. The chain is coupled to a drive sprocket on the rear wheel to transmit the tension supplied by the foot pedal to a rotation of the drive sprocket, and consequently the rear wheel of the scooter. A one-way clutch permits counter rotation of the drive sprocket during the return of the foot pedal and the chain to the original position, which is aided by a return spring. The scooter is preferably also equipped with a folding mechanism including a linkage that locks in an open position to prevent inadvertent collapse of the scooter, and can quickly be manually disengaged to allow the scooter to fold compactly onto itself.

### CROSS-REFERENCE TO RELATED APPLICATION

This application relates to U.S. Provisional Application No. 60/385,045, filed on Jun. 1, 2002, and U.S. Provisional Application No. 60/417,111, filed on Oct. 9, 2002.

### BACKGROUND OF THE INVENTION

1. Field of the Invention

The present invention is directed generally to human powered scooters, and more particularly to a pedal driven scooter with a simplified drive system and foldable capabilities including a self-locking mechanism.

2. Description of Related Art

The scooter has been a favorite mode of transportation since its origin in Germany in the early eighteen hundreds, and has recently enjoyed a tremendous surge in popularity with the success of the streamline lightweight models that have hit the market in the last few years. Scooters serve as both amusement devices for children as well as transportation for adults, and can even be used for performing stunts and tricks. They are typically comprised of a front and rear wheel (or set of wheels) mounted to a chassis upon which the rider may stand, and a steering column and handle bars connected to the chassis and coupled the front wheel for navigating the scooter. The chassis can comprise an elongate platform to rest the user's foot or feet when coasting, while the user propels the scooter by pushing off the ground. The simplicity, mobility, versatility, and light-weight nature of the scooter has kept it one of the most enjoyed modes of transportation for almost two hundred years.

Among the many advances that the scooter has experienced is the advent of drive systems that assist the user when riding the scooter. Drive systems have included motorized systems of electric and internal combustion types, but such human assisted systems add significantly to the cost, complexity, and weight of the scooter. Human powered drive systems, on the other hand, do not complicate the basic scooter significantly, and can add both enjoyment and efficiency as an alternative to the step and push mode of propulsion.

Pedal powered scooters of the prior art have included a set of gears to communicate a driving force applied at the pedal to the rear wheel of the scooter. U. S. Pat. No. 4,761,014 to Huang entitled “Propulsion of Scooters” discloses a pedal powered scooter that is equipped with a mechanical drive for the rear wheel comprising a ratchet mechanism, a stepper lever, and a retrieving means. The ratchet mechanism drives the rear wheel, the stepping lever transfers the stepping force of the rider to the ratchet mechanism, and the retrieving means raises the stepping lever to the original position as the stepping force is released. In this manner, the scooter is purportedly propelled by the intermittent force supplied by the rider to advance the scooter.

U. S. Pat. No. 5,192,089 to Taylor entitled “Pedal-Operated Scooter” discloses a pedal operated drive system for unidirectionally propelling the rear wheel to propel the scooter. The drive system includes a pedal pivotally mounted on the scooter frame, with front and rear cables extending around corresponding cable pulleys and attached to corresponding sprocket chains. The sprocket chains engage corresponding parallel sprocket adapted for alternatively driving the rear wheel when rotated in the forward direction and disengaging for free rotation in the opposite direction. A spring connects one end of the sprocket chains and engages a pair of spaced chain pulleys for alternatively maintaining one set of the sprocket chains and connecting cables in tension responsive to free rotation of the corresponding sprocket when the opposite sprocket is being driven by the opposing sprocket chain and cable.

U. S. Pat. No. 6,419,251 to Chueh entitled “Propelling Scooter” discloses a scooter with an elongated pedal disposed longitudinally above the chassis. The pedal has a backward end and a forward end, and is pivotally connected to the chassis between the ends thereof and adapted to sway relative to the chassis. The scooter further includes a driving pulley securely attached to a center of the rear wheel, and a primary flexible drive piece received around the driving pulley and the driven pulley to transmit rotation from a first shaft to the rear wheel such that the scooter may move forward when the first shaft is rotated relative to the chassis. The scooter further includes means for transmitting motion from the pedal to the first shaft in a manner of causing rotation of the first shaft invariably in the correct direction.

As these references demonstrate, previous pedal driven systems are fairly complex. The art lacks a simple propulsion system for a pedal driven scooter that reduces the number of components and increases the reliability and simplicity of the scooter.

### SUMMARY OF THE INVENTION

A scooter incorporating a simplified human powered pedal drive system that is lightweight, efficient, simple, and more practical than scooter propulsion systems of the prior art is disclosed. Including the basic components of scooter technology (steering column and handle bar, front wheel, rear wheel, and standing platform), the present invention also incorporates a foot pedal coupled to a drive lever that is coupled to an idler sprocket. A chain anchored to the scooter frame at a distal end is fed over the idler sprocket and also a drive sprocket mounted on the rear wheel. The chain is tethered at a proximal end to a tensioning mechanism such as a spring for maintaining tension in the chain. The drive sprocket is further coupled to a one-way clutch for allowing free rotation in a counter direction while driving the rear wheel in the opposite direction. In operation, the rider places a foot over the foot pedal and applies pressure to the pedal until the pedal pivots about a pivot pin. The rotation of the foot pedal causes the drive lever to rotate away from the rear wheel, and the idler sprocket displaces a portion of the chain causing the chain to be placed in tension. The tension on the drive chain causes the drive sprocket on the rear wheel to rotate in the forward direction, where frictional contact with the ground surface propels the scooter in the forward direction. Tension is maintained by the spring at the proximal end of the chain as the “stroke” of the pedal is completed. After the pedal stroke is completed, the rider releases the pressure from the foot pedal and a restoring force such as a spring member forces the foot pedal back to the original, undeployed position. As the pedal is returned, the drive chain retreats in the opposite direction to its previous travel, but the clutch on the drive sprocket of the rear wheel accommodates the reverse direction of the chain and sprocket without imparting a corresponding rotational force on the rear wheel. Thus, the one-way clutch only drives the scooter in the downward stroke of the foot pedal, and permits free rotation in the return phase of the pedal stroke. In a preferred embodiment, the chain is controlled between its end only by the idler sprocket coupled directly to the pedal's motion and the drive sprocket on the rear wheel.

The drive system of the present invention is preferably accompanied by a folding mechanism that permits quick storage and easy transportation of the scooter when not in use. The steering column of the scooter is pivotally mounted to the platform of the scooter by an axle that allows the scooter to fold upon itself when not in use. To prevent inadvertent collapsing of the scooter when in use, the present invention incorporates a self-locking hinge joint that automatically locks when the scooter is deployed and is easily manually disengaged when the scooter is to be folded up. A pair of upper links is mounted to a single lower link so as to provide free rotation of the respective links at the connection point. The upper links are connected to the steering column, and the lower link is connected to the standing platform of the scooter. When the scooter is folded up, the lower link rotates with the steering column until it forms a small acute angle with the standing platform, while the upper links are oriented almost parallel to the standing platform. When the scooter is unfolded, the upper links rotate away from the lower link as the lower link rotates away from the standing platform. The upper links rotate beyond one hundred eighty degrees from the lower link, forming a stability condition where compression of the linkage prevents the link from collapsing. That is, from beyond a one-hundred eighty degree angle compression tends to maintain the linkage in its open configuration preventing inadvertent collapsing of the scooter. To disengage the linkage, one manually depresses the linkage at its connection between the upper and lower links to return the linkage first to one hundred eighty degrees (linear) and then below one hundred eighty degrees where the scooter then freely collapses. In this manner, the scooter has a quick, reliable folding mechanism that is protected from accidental actuation by the self-locking feature of the present invention.

### BRIEF DESCRIPTION OF THE DRAWINGS

FIG. 1 is an elevated, perspective view of a first preferred embodiment of the present invention;

FIG. 2 is an enlarged, elevated perspective view, partially exploded, of the pedal drive system of the embodiment of FIG. 1;

FIG. 3 is an enlarged, side view of the pedal drive system of the embodiment of FIG. 1;

FIG. 4 is an enlarged, elevated perspective exploded view of the rear wheel assembly of the embodiment of FIG. 1;

FIG. 5 is an enlarged, elevated perspective view, partially exploded, of the folding mechanism of the embodiment of FIG. 1;

FIG. 6 is an elevated perspective view of the embodiment of FIG. 1 in the folded configuration;

FIG. 7 is an enlarged, elevated perspective view of the folding mechanism of the embodiment of FIG. 1 in the folded configuration;

FIG. 8 is a side view of a second preferred embodiment of the present invention; and

FIG. 9 is a side view of the embodiment of FIG. 8 in the folded configuration.

### DETAILED DESCRIPTION OF THE PREFERRED EMBODIMENTS

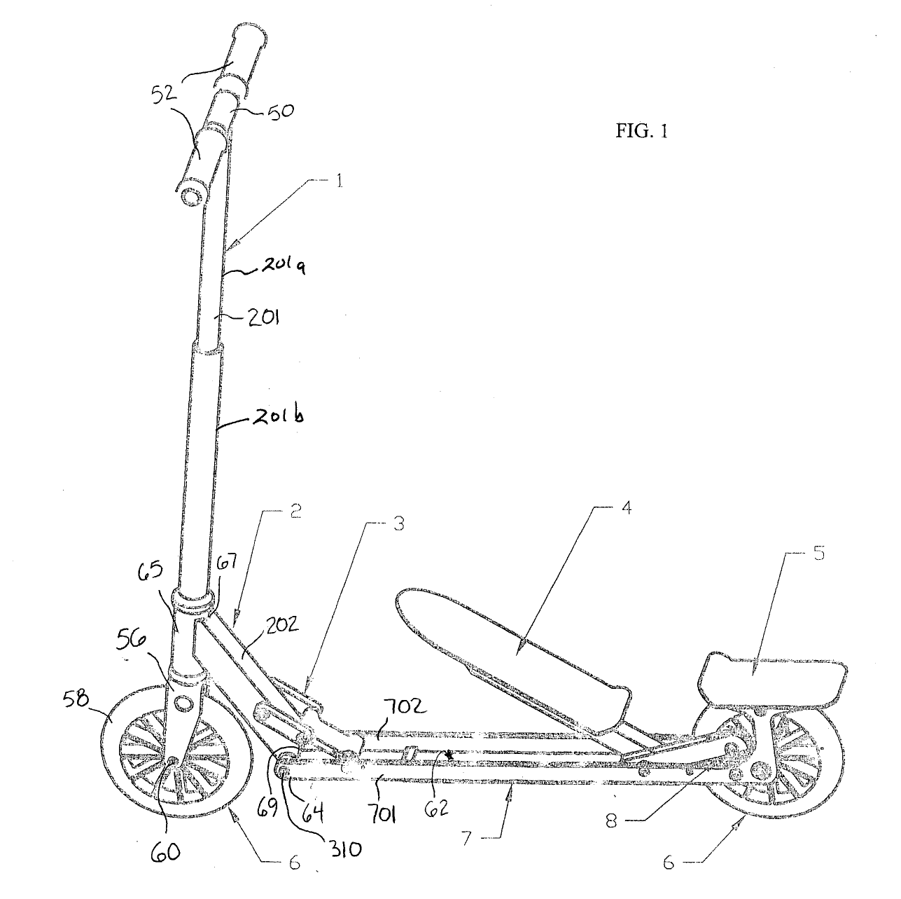

An exemplary embodiment of a scooter with a pivoting pedal drive system is illustrated in FIG. 1. The scooter may be segregated into eight general assemblies: a steering assembly 1, a down tube assembly 2, a folding mechanism assembly 3, a foot pedal assembly 4, a rear elevated platform assembly 5, a rear wheel assembly 6, a main frame or chassis assembly 7, and a drive train assembly 8.

In the embodiment shown in FIG. 1, the steering assembly 1 is substantially standard and comprises a handle bar 50 with right and left handles 52 perpendicularly mounted to a head tube 201. In a preferred embodiment the head tube 201 can comprise two or more components 201a and 201b that can telescope to various lengths to accommodate different size riders. The head tube 201 is connected to a fork 56 that supports the front wheel 58. Front wheel 58 is rotatably mounted to the fork 56 at the axle 60, and a left or right rotation of the handle bar 50 causes a corresponding rotation of the front wheel 58 as is known in the art.

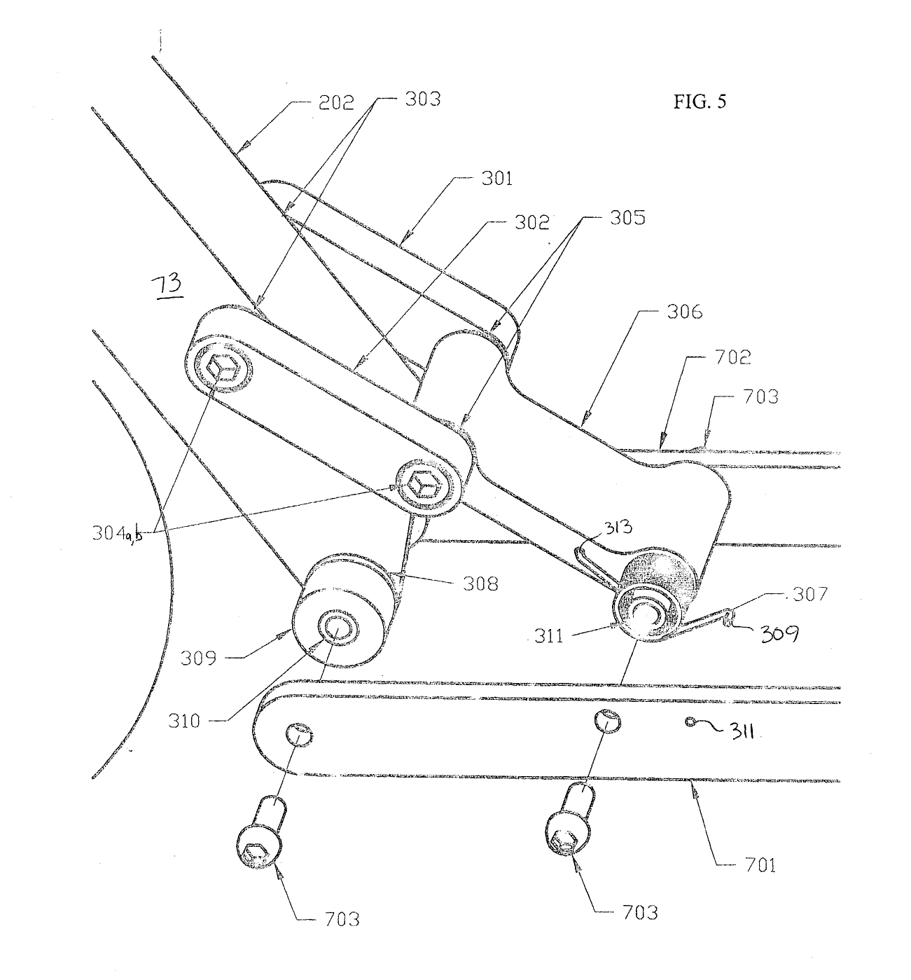

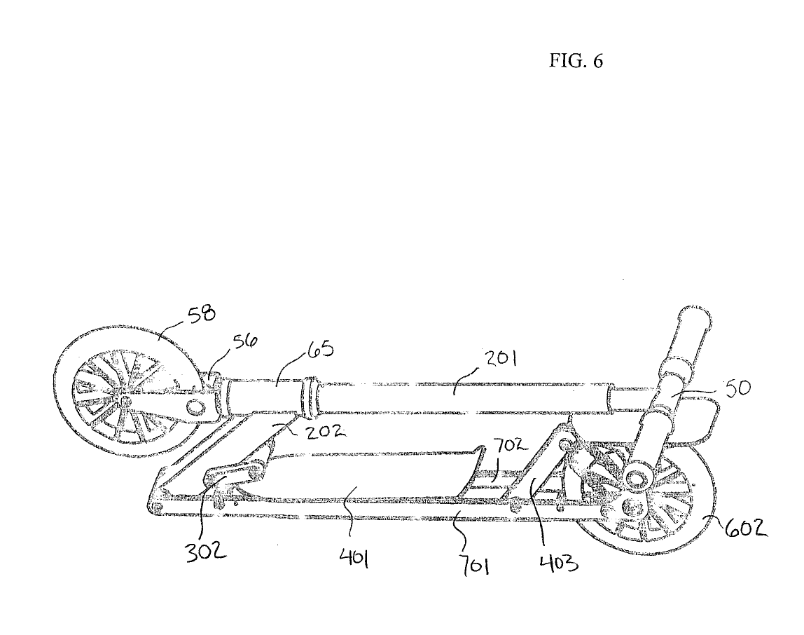

The frame assembly 7 of the preferred embodiment may include a left frame piece 701 spaced horizontally from a right frame piece 702 to form a gap 62 therebetween. At a proximal end 64 of the left and right frame pieces 701,702, a down tube 202 is provided that connects the frame assembly 7 with the steering assembly 1. The down tube 202 is rigidly mounted at a first end 67 to a collar 65 that mounts the fork 56 of the steering assembly 1 in a welded or fastener affixed relationship, and is pivotally mounted at a second end 69 to the left and right frame pieces 701,702 via a down tube pivot axle 310. The pivoting assembly (FIG. 5) of the connection between the down tube 202 and the frame assembly 7 includes a pair of spacers 309 and washers 308 sandwiched between the adjoining face of the corresponding frame piece and the outer face 73 of the down tube 202. The pivoting connection of the frame assembly 7 and the steering mechanism 1 at the down tube pivot axle 310 allows the scooter to fold up onto itself as shown in FIG. 6. The scooter preferably includes a folding mechanism described below to prevent the scooter from inadvertently folding or collapsing while in use.

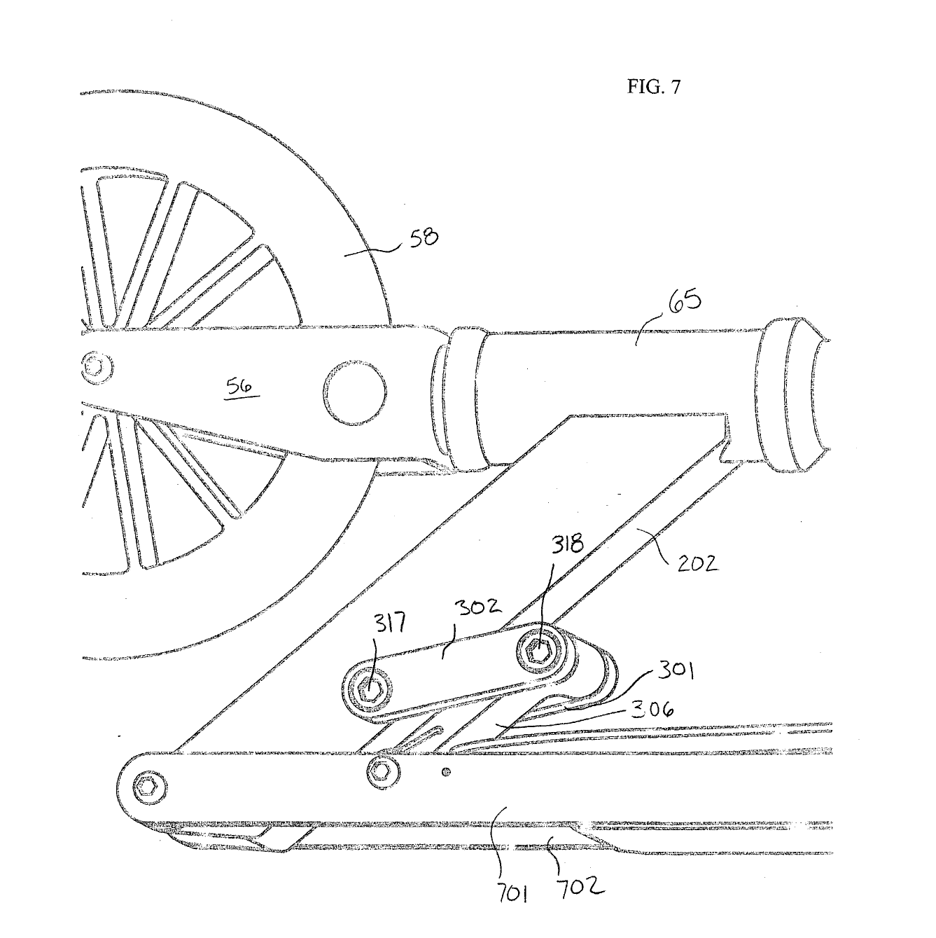

The folding mechanism 3 of the present invention (as shown in FIGS. 5 and 7) connects the frame assembly 7 to the down tube 202. The folding mechanism 3 comprises a left upper link 302 and a right upper link 301 pivotally connected at a first (upper) end to the down tube 202. A first link bolt 317 passes through an aperture 304a on the right upper link and left upper link of the folding mechanism 3, where a washer (not shown) is sandwiched in the space 303 between each link and the down tube's lateral faces 73. The upper links 301,302 swing freely about the first link bolt 317 in a pivoting relationship. The second (lower) end of the left and right links 302,301 are pivotally connected to an upper portion of a lower link member 306 at aperture 304b via a second link bolt 318. The lower link 306 is pivotally mounted at its lower extremity to the frame assembly 7 at the left and right frame pieces 701, 702 by a lower link pivot axle 311. Pins 703 pass through holes in the right and left frame pieces and into the lower link pivot axle 311 to fix the lower link 306 between the right and left frame pieces in a rotating relationship. At the lower end of the lower link 306 is a torsional spring 307 including a first end 309 secured to the frame piece 701 at hole 311, and a second end 313 connected to the lower link 306. The lower link pivot axle 311 is aligned through the spring.

The folding mechanism comprising the down tube 202, the frame pieces 701,702, and the upper and lower links 301, 302, 306, respectively, form a triangle when the links are aligned linearly. As shown in FIG. 5, the torsional spring 307 biases the lower link 306 to rotate about the axle 311 toward the down tube 202 until the lower link contacts the down tube 202 or contacts a stopper (not shown), terminating the rotation. When the linkage is properly spaced, the rotation of the lower link 306 in the biased direction expands the included angle between the upper links 301,302 and the lower link 306 from an acute angle to one hundred eighty degrees (linear) and then continues slightly further as the angle is increased beyond the one hundred eighty degree value. As the lower link 306 reaches its final position against the down tube 202 or stopper, an oblique angle slightly greater than one hundred eighty degrees is created between the lower link 306 and the upper links 301,302. With the upper and lower links rotated to this position, further compression on the linkage as might occur when the handle bars are pulled back during operation of the scooter fixes the linkage in the open configuration. The folding mechanism effectively locks against a counter rotation of the down tube 202 about the frame assembly 7. This automatic locking function prevents the scooter from folding inadvertently as the scooter is being ridden, where a rider may pull back on the handle tending to fold the scooter.

To fold the scooter to its compact orientation shown in FIG. 6, the scooter must be unoccupied. The linkage comprising the upper links 301,302 and the lower link 306 can be manually rotated by applying a force to the juncture of the linkage and against the biasing force of the torsional spring 307 until the included angle formed between the upper and lower links is first equal to, and then below one hundred eighty degrees. Once the relative rotation of the two links has reached this orientation, the automatic locking feature of the folding mechanism is deactivated and the scooter can easily be folded as shown in FIG. 6 in a compact fashion. As the steering assembly 1 rotates toward the frame assembly 7, the upper and lower links continue to rotate until their included angle is very acute.

The forgoing folding mechanism allows the steering assembly to automatically lock into a secure and rigid configuration once unfolded into the operable position. Although a secondary locking mechanism may be utilized, the links are automatically restrained by the use of the spring 307. Additional embodiments can be made by changing the location and type of spring that is used. The torsional spring can be located at the upper end of the lower link 306 or at the upper end of the upper links. Alternatively, a linear spring could be used and mounted to either the upper or lower links. The shape and number of the individual links can be changed to produce a common result without departing from the scope of the invention. Another embodiment includes adding knobs or handles on either the upper or lower links that would facilitate opening and closing the mechanism. For example, a knob could be mounted on the lower end of the upper link to make it easier for the rider to grab the link and rotate it against the force of the spring.

The addition of a second locking device for securing the folding mechanism in the open or closed position may be included. An example is a locking mechanism that utilizes a cam type compression device on one or more of the link pivots. Another device for locking the links in position includes a hook and/or latch, including a spring loaded latch that ensures that the mechanism is engaged. Yet another variation is varying the size and arrangement of the linkages to create the locking operation.

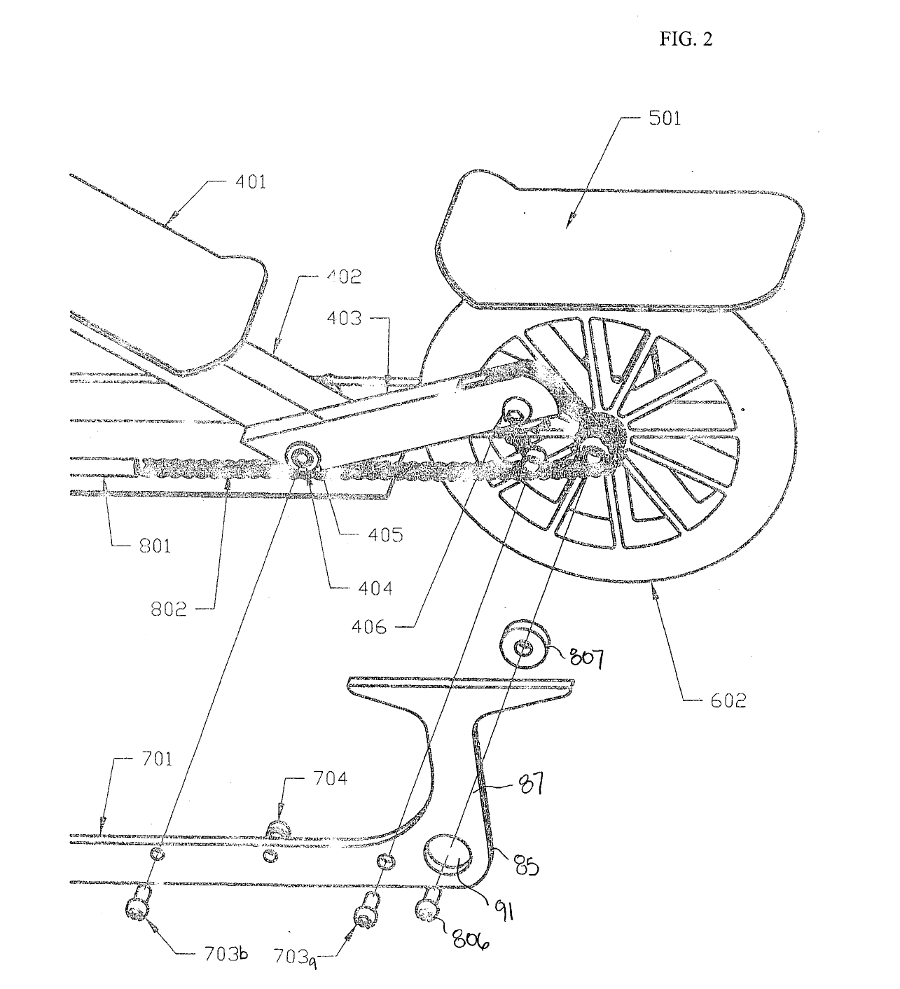

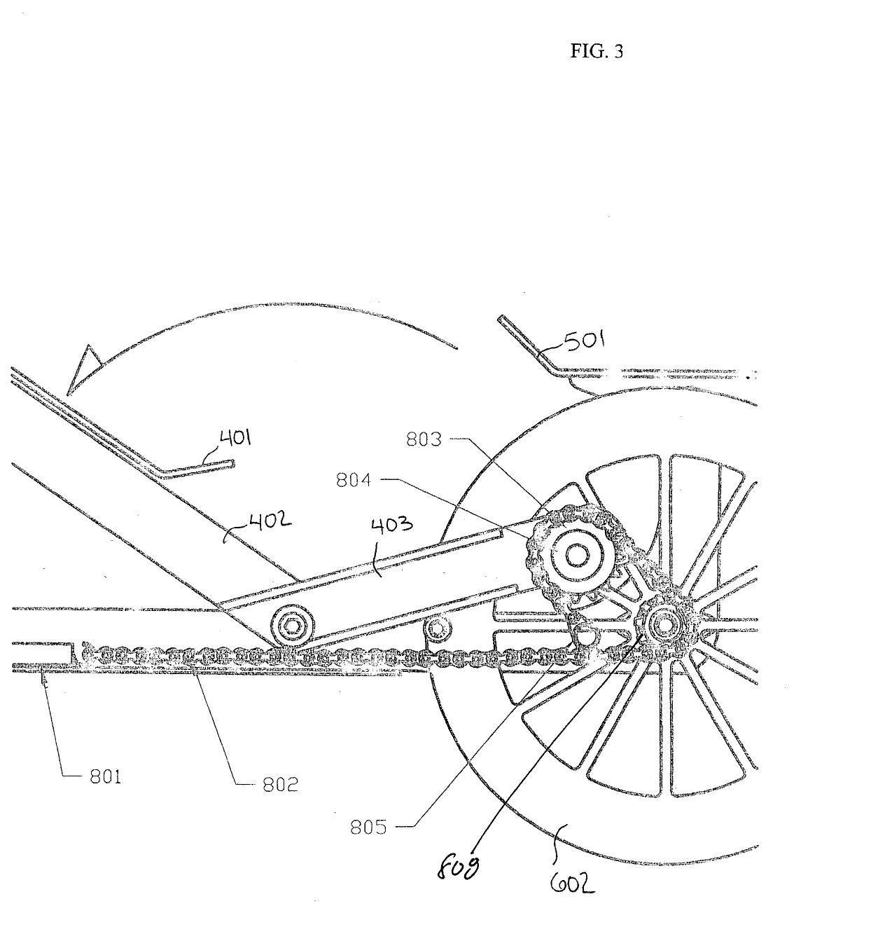

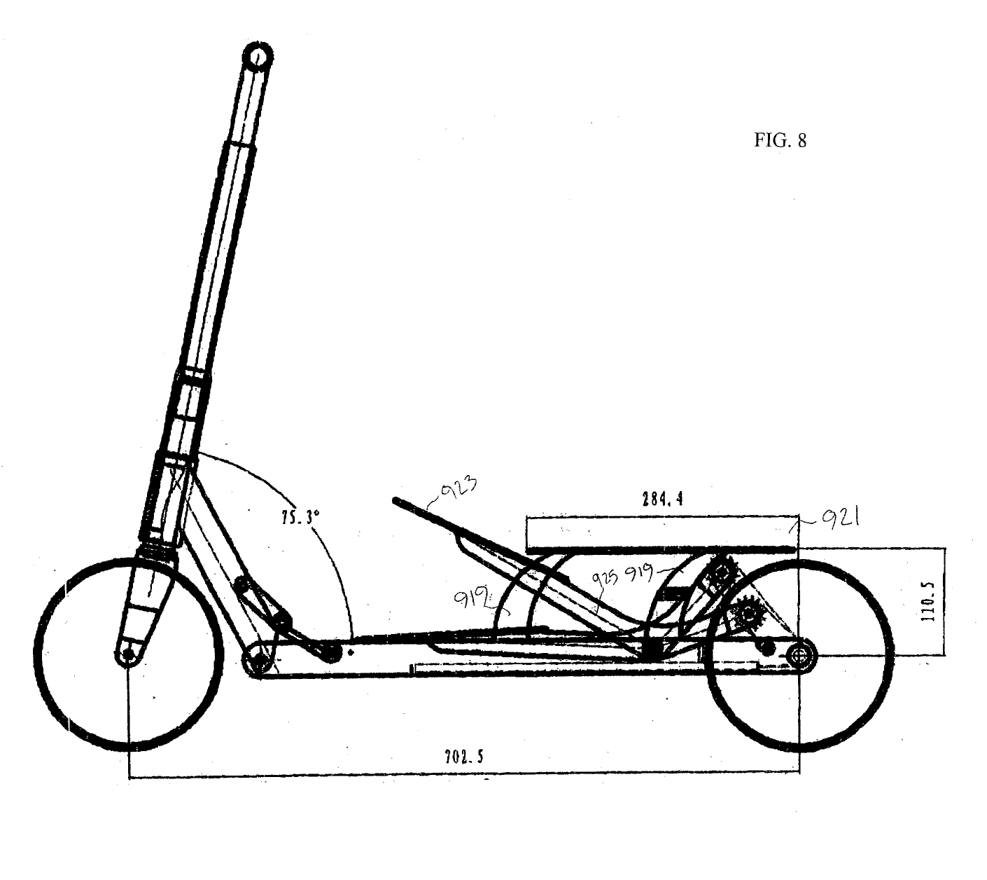

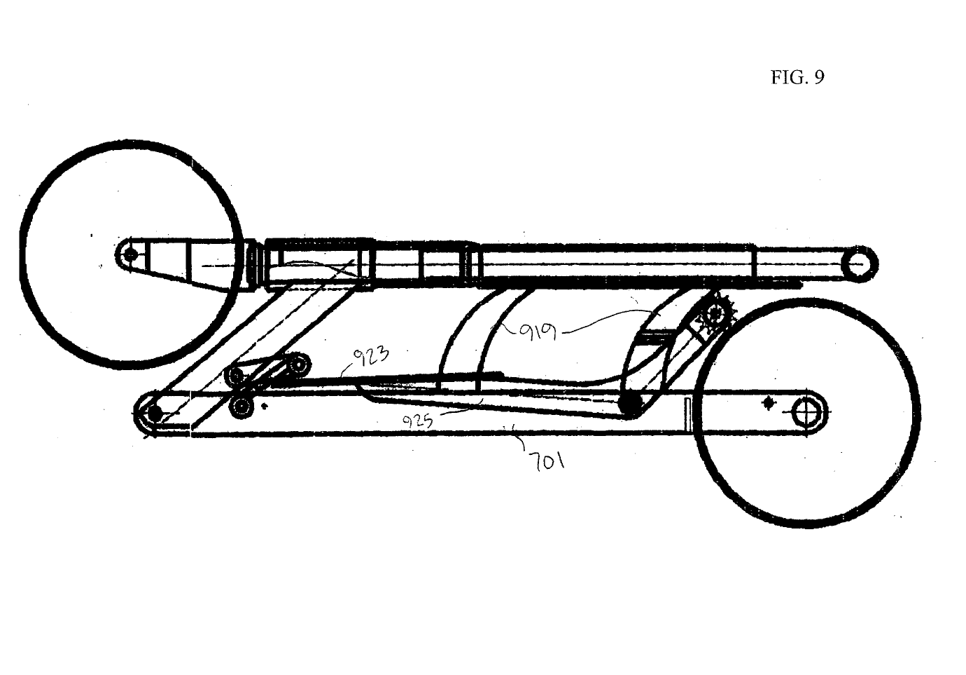

The scooter of the present invention is equipped with a novel pedal drive system to propel the scooter using a foot pedal coupled to a drive chain that turns the rear wheel of the scooter. As shown in FIGS. 2 and 3, the right and left frame pieces 701, 702 of the scooter's chassis include at a distal end 85 a perpendicular arm 87 for supporting an upper rear platform 501. The juncture of the frame piece and perpendicular arm includes an aperture 91 for receiving the rear axle of the scooter that mounts the rear wheel 602. The rear wheel 602 rotates freely about the rear axle below the upper rear platform 501. The upper rear platform 501 is vertically spaced from the frame assembly in a preferred embodiment and is structurally configured to bear the entire weight of the intended rider. A rider places one foot on the upper rear platform 501 while pedaling the scooter and both feet while coasting on the scooter, such that the platform supports the weight of the rider. In a preferred embodiment the platform is extended substantially over the rear wheel as shown more particularly in FIGS. 8 and 9. In this embodiment, support members 919 brace the extended platform 921 above the chassis, where the majority of the foot pedal propulsion system resides between the platform and the frame assembly. In this embodiment the foot pedal 923 and the foot pedal lever 925 may be lengthened to accommodate the increased length of the platform 921. The features of the embodiment of FIGS. 8 and 9 are otherwise unchanged.

The frame assembly includes at a mid portion a foot pedal assembly 4 for driving the scooter. FIG. 2 illustrates the rearward components in a partially exploded view. The foot pedal assembly 4 comprises a foot pedal 401 that is mounted on a foot pedal lever 402, which in turn is coupled to a drive lever 403. The foot pedal lever 402 and drive lever 403 form a generally L-shaped member that transmits force applied at the foot pedal 401 to the end of the drive lever 403. Although in a preferred embodiment foot pedal lever 402 and drive lever 403 form an L-shaped with said respective levers positioned at a 90° angle, those skilled in the art will understand that the angle between the levers can be less than or greater than 90° provided that upon downward movement of the foot pedal lever 402 the desired rotation is provided to drive sprocket 808 as discussed below. The generally L-shaped member is secured to the frame assembly in a pivoting relationship by pivot rod 404 and washer 405 mounted to the chassis by fastener 703b. The foot pedalassembly is connected to the rear wheel by virtue of the drive train assembly 8 described more fully below.

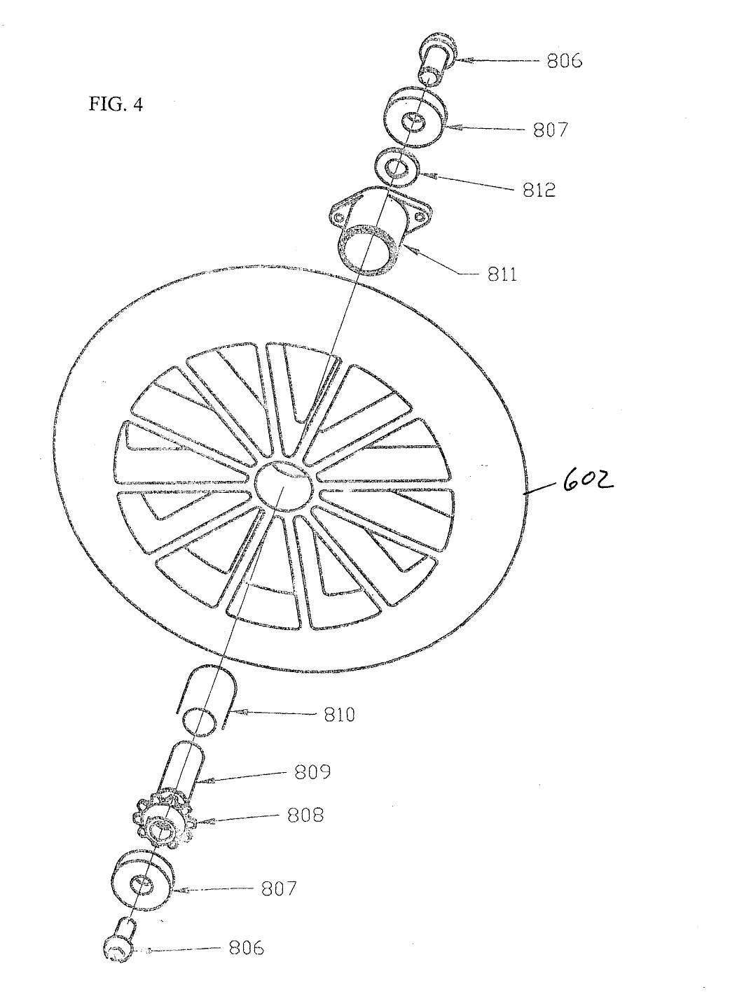

FIGS. 2 and 3 illustrate the layout of the drive train assembly. At the upper end of the drive lever 403 is an idler sprocket 803 journaled on idler sprocket bearing 804. The chain drive consists of a tension spring 801 that is connected at one end to the frame 701 and at its other end to one end of a drive chain 802. The other end of the drive chain 802 is routed over and carried by a drive sprocket 808 and the idler sprocket 803, and the end of the chain 802 is fixed to chain anchor 805 secured to the frame assembly by fastener 703a. The drive sprocket 808 is mounted an a drive axle 809 as shown more particularly in FIG. 4, and the drive axle 809 is centered inside a needle roller clutch 810. The needle roller clutch 810 is mounted concentrically inside a clutch housing 811. The drive axle is mounted to the inside of an axle bearing 807 on both ends by means of an axle bolt 806.

In operation, a rider places one foot on the upper rear platform 501 and places a second foot over the foot pedal 401. This position allows the rider to rest one foot while stabilizing the body and bearing the weight on the foot on the platform. This provides greater control over previous systems that require both feet to provide locomotion. The drive foot pushes down on the foot pedal 401, pivoting the foot pedal lever 402 and the drive lever 403 about the pivot pin 404, raising the end of the drive lever 403 and separating the idler sprocket 803 from the drive sprocket 808. With the drive chain fixed at its distal end at the chain anchor 805, the relative motion of the idler sprocket 803 upward and away from the drive sprocket 808 places the chain 802 in tension. The tension in the chain 802 is transferred to the drive sprocket 808 imparting a rotational force thereon. With the chain 802 anchored to the frame, the drive chain speed is doubled compared with the idler sprocket 803 producing a high rotational speed on the rear axle 809 that drives the rear wheel 602. Once the foot pedal 401 reaches the bottom limit of its travel path the rider releases the pressure on the pedal and a tension spring returns the pedal to its uppermost position. The needle roller clutch 810 allows the drive axle 809 to rotate freely in the opposite direction of the rear wheel 602 as the pedal resets. The opposite end of the drive chain 802 is secured to a tension spring 801 mounted on the frame assembly 7. Tension applied to the chain 802 from the tension spring 801 reduces slack in the chain as the chain recoils and is led out by the operation of the pedal drive system. Alternatively, the chain slack can be taken in by a spool biased in a first rotational direction to maintain tension on the chain.

The drive chain of the present invention is lighter, simpler, and more cost effective than previous designs. A particular advantage is the increased efficiency afforded by the simple drive system of the present invention. Although the description above contains particular embodiments of the present invention, these embodiments should not be construed as limiting with respect to the scope of the invention but merely providing illustrations of some of the presently preferred embodiments. Thus, the scope of the invention should be determined by the appended claims and their legal equivalents, rather than by any specific embodiment described.

What is claimed is:

1. A human powered scooter comprising:
a steering column including a handle bar;
a front wheel coupled to the steering column;
a rear wheel including an axle, a drive sprocket mounted thereon, and a unidirectional clutch transmitting force from said drive sprocket to the rear wheel axle in a first rotational direction only;
a frame assembly horizontally disposed before said front end and rear wheels wherein a first end of said frame assembly is connected to the steering column and the second end of said assembly is connected to the rear wheel axle;
a support platform;
a foot pedal system mounted on the frame assembly including: a chain anchored at a first end to the frame assembly, and at a second end to a tension-maintaining device, and carried by said drive sprocket at an intermittent portion of said chain; and a generally L-shaped lever comprising a foot pedal support, a drive arm, and an elbow at the juncture between the foot pedal support and drive arm, said generally L-shaped lever mounted to the frame assembly in a pivoting relationship at said elbow, said drive arm having an idler sprocket at a distal end carrying the chain between the anchored first end and the drive sprocket; whereupon pressure on the pedal support sufficient to rotated the pedal support about the elbow causes the idler sprocket to induce a tension in the chain for rotating the drive sprocket on the rear wheel.

2. The scooter of claim 1 wherein the tension-maintaining device is a coiled spring.

3. The scooter of claim 1 further comprising a foot pedal mounted on the foot pedal support.

4. The scooter of claim 1 further comprising a pedal return mechanism for counter-rotating the foot pedal support once said pressure is discontinued.

5. The scooter of claim 1 wherein the support platform is vertically spaced from the frame assembly above the rear wheel.

6. The scooter of claim 5, wherein the foot pedal system is substantially disposed between the frame assembly and the support platform.

7. The scooter of claim 1 wherein the only two sprockets that carry the chain are the idler sprocket on the drive lever and the drive sprocket on the rear wheel axle.

8. The scooter of claim 1 including an unintentional folding prevention system comprising:
a lower link having opposing ends pivotally mounted at one end to the frame assembly;
an upper link having opposing ends connected pivotally at one end to the lower link at its second end, and connected pivotally at said upper links opposite end to the steering column, a spacing between the connection of the lower link at the frame assembly and the upper link at the steering column providing for a maximum extension of the steering column when the upper and lower links are one hundred eighty degrees apart;
a spring biasing said one of said upper and lower links to an unfolded position;
where the biasing rotates the lower link and the upper link to an overextended position greater than one hundred eighty degrees with respect to the included angle between the lower link and the upper link, such that compression of the upper and lower links at such overextended position resists unintentional folding of the scooter.

9. The scooter of claim 8 wherein said overextended position can be manually disengaged by applying pressure to a juncture of the upper and lower links to allow folding of the scooter.

10. The scooter of claim 8 where the spring is a torsional spring coupled to the lower link.

11. The scooter of claim 8 where the spring is a torsional spring coupled to the upper link.

12. The scooter of claim 8 wherein the upper link comprises a pair of rigid members and the lower link comprises a unitary member.

13. The scooter of claim 8 wherein the steering column includes an inclined bar extending from to the frame assembly, the upper link secured in a pivotal relationship to said inclined bar.

14. The scooter of claim 8 wherein the tension-maintaining device is a coiled spring.

15. The scooter of claim 8 further comprising a foot pedal mounted on the foot pedal support.

16. The scooter of claim 8 further comprising a pedal return mechanism for counter-rotating the foot pedal support once said pressure is discontinued.

17. The scooter of claim 8 wherein the support platform is vertically spaced from the frame assembly.

18. The scooter of claim 7, wherein the foot pedal system is substantially disposed between the frame assembly and the support platform.

19. The scooter of claim 8 wherein the only two sprockets that carry the chain are the idler sprocket on the drive lever and the drive sprocket on the rear wheel axle.

20. A pedal driven scooter comprising:
a chassis comprising a front wheel, a rear wheel, a frame supporting said front and rear wheels, and a steering column to control the front wheel;
a platform spaced vertically from the chassis for supporting a rider thereon;
a pedal assembly for propelling the scooter by the rider from the platform comprising:
a drive sprocket mounted on the rear wheel for one way transmission of force to rotate the rear wheel;
a chain carried by the drive sprocket for providing the force, the chain anchored to the chassis at a first end and attached at a second end to a tensioning device;
a foot pedal pivotally mounted to the chassis;
a return mechanism for biasing the foot pedal in a ready position; and
an idler sprocket coupled to the foot pedal for placing the chain in tension when a pressure is applied to said foot pedal by the rider's foot, where said tension in said chain providing the force to rotate the rear wheel.

21. A scooter comprising:
a steering column including a handle bar at a first end and a fork at a second end for receiving a front wheel;
a frame supporting a rear wheel and mounted to the steering column in a pivoting relationship such that said steering column folds on top of the frame;
a linkage connecting the frame and the steering column and comprising a lower link pivotally mounted to the frame and an upper link pivotally mounted to the steering column, the upper link pivotally mounted to the lower link, where the linkage is linear when the steering column is rotated to its maximum angular separation between the frame; and
a biasing member cooperating with the linkage to bias the included angle between the lower link and the upper link to greater than one hundred eighty degrees and where
compression of the linkage when said included angle is greater than one hundred eighty degrees provides assistance to the steering column unintentionally folding on the frame.
